(19) United States
(12) Patent Application Publication
(10) Pub. No.: US 2015/0085123 A1
(43) Pub. Date: Mar. 26, 2015

(54) METHOD AND APPARATUS FOR MONITORING A CONDITION OF AN OPERATING IMPLEMENT IN HEAVY LOADING EQUIPMENT

(71) Applicant: MOTION METRICS INTERNATIONAL CORP., Vancouver (CA)

(72) Inventors: Shahram TAFAZOLI BILANDI, Vancouver (CA); Neda PARNIAN, Coquitlam (CA); Matthew Alexander BAUMANN, Vancouver (CA); Sina RADMARD, Vancouver (CA)

(21) Appl. No.: 14/493,096

(22) Filed: Sep. 22, 2014

Related U.S. Application Data
(60) Provisional application No. 61/881,262, filed on Sep. 23, 2013.

(51) Int. Cl. G01M 99/00; H04N 7/18; G01N 21/84

(52) U.S. Cl. CPC G01M 99/005; G01N 21/84; H04N 7/188
USPC 348/148

(57) ABSTRACT

A method and apparatus for monitoring a condition of an operating implement in heavy equipment is disclosed. The method involves receiving a trigger signal indicating that the operating implement is within a field of view of an image sensor, and in response to receiving the trigger signal, causing the image sensor to capture at least one image of the operating implement. The method also involves processing the at least one image to determine the condition of the operating implement. A visual or audio warning or alarm may be generated for preventing significant damage to the processing equipment and avoid safety hazards involved.

### BACKGROUND OF THE INVENTION

1. Field of Invention

This invention relates generally to image processing and more particularly to processing of images to monitor a condition of an operating implement in heavy equipment.

2. Description of Related Art

Heavy equipment used in mining and quarries commonly includes an operating implement such as a bucket or shovel for loading, manipulating, or moving material such as ore, dirt, or other waste. In many cases the operating implement has a sacrificial Ground Engaging Tool (GET) which often include hardened metal teeth and adapters for digging into the material. The teeth and/or adapters may become worn, damaged, or detached during operation. Wear in the implement is natural due to its contact with often abrasive material and is considered a sacrificial component which serves to protect the longer lasting parts of the GET.

In a mining operation, a detached tooth and/or adapter may damage downstream equipment for processing the ore. An undetected broken tooth and/or adapter from a loader, backhoe, or mining shovel can also cause safety risk since if the tooth enters an ore crusher, for example, the tooth may be propelled at a very high speed due to rotation of the crusher blades thus presenting a potentially lethal safety risk. In some cases the tooth may become stuck in the downstream processing equipment such as the crusher, where recovery causes downtime and represents a safety hazard to workers. The broken tooth may also pass through the crusher and may cause significant damage to other downstream processing equipment, such as for example longitudinal and/or lateral cutting of a conveyor belt.

For electric mining shovels, camera based monitoring systems are available for installation on a boom of the shovel, which provides an unobstructed view of the bucket from above. The boom also provides a convenient location for the monitoring system that is generally out of the way of falling debris caused by operation of the shovel. Similarly, for hydraulic shovels, camera based monitoring systems are available for installation on the stick of the shovel, which provides an unobstructed view of the bucket. Such monitoring systems may use bucket tracking algorithms to monitor the bucket during operation, identify the teeth on the bucket, and provide a warning to the operation if a part of the GET becomes detached.

There remains a need for monitoring systems for other heavy equipment such as front-end loaders, wheel loaders, bucket loaders, and backhoe excavators, which do not provide a convenient location that has an unobstructed view of the operating implement during operations.

### SUMMARY OF THE INVENTION

In accordance with one disclosed aspect there is provided a method for monitoring a condition of an operating implement in heavy equipment. The method involves receiving a trigger signal indicating that the operating implement is within a field of view of an image sensor, and in response to receiving the trigger signal, causing the image sensor to capture at least one image of the operating implement. The method also involves processing the at least one image to determine the condition of the operating implement.

Receiving the trigger signal may involve receiving a plurality of images from the image sensor and may further involve processing the plurality of images to detect image features corresponding to the operating implement being present within one or more of the plurality of images, and generating the trigger signal in response to detecting the image features.

Receiving the trigger signal may involve receiving a signal from a motion sensor disposed to provide a signal responsive to movement of the operating implement, and generating the trigger signal in response to the signal responsive to movement of the operating implement indicating that the operating implement is disposed within the field of view of the image sensor.

Receiving the signal responsive to movement of the operating implement may involve receiving a spatial positioning signal representing an orientation of a moveable support carrying the operating implement, and generating the trigger signal may involve generating the trigger signal in response to the spatial positioning signal indicating that the support is disposed in a spatial position that would place the operating implement within the field of view of the image sensor.

Receiving the signal from the motion sensor may involve receiving signals from a plurality of motion sensors disposed to provide signals responsive to movement of the operating implement.

The method may involve generating a system model, the system model being operable to provide a position and orientation of the operating implement based on the motion sensor signal.

The moveable support may include a plurality of articulated linkages and receiving the spatial positioning signal may involve receiving spatial positioning signals associated with more than one of the linkages and wherein generating the trigger signal may include generating the trigger signal in response to each of the spatial positioning signals indicating that the support is disposed in a spatial position that would place the operating implement within the field of view of the image sensor.

Receiving the signal from the motion sensor may involve receiving a signal from at least one of an inertial sensor disposed on a portion of the heavy equipment involved in movement of the operating implement, a plurality of orientation and positioning sensors disposed on a portion of the heavy loading equipment involved in movement of the operating implement, a range finder disposed to detect a position of the operating implement, a laser sensor disposed to detect a position of the operating implement, and a radar sensor disposed to detect a position of the operating implement.

Receiving the trigger signal may involve receiving a signal from a motion sensor disposed to provide a signal responsive to a closest obstacle to the heavy equipment, and generating the trigger signal in response to the signal responsive to the closest obstacle indicating that the closest obstacle is within an operating range associated with the operating implement.

Receiving the signal from the motion sensor may involve receiving a signal from one of a laser scanner operable to scan an environment surrounding the heavy equipment, a range finder operable to provide a distance to obstacles within the environment, a range finder sensor operable to detect objects within the environment, and a radar sensor operable to detect objects within the environment.

Receiving the trigger signal may involve receiving a first signal indicating that the operating implement is within a field of view of an image sensor, receiving a second signal indicating that a wearable portion of the operating implement is within the field of view of an image sensor, and generating the trigger signal in response to receiving the second signal after receiving the first signal.

Receiving the second signal may involve receiving a plurality of images from the image sensor and may further involve processing the plurality of images to detect image features corresponding to the wearable portion of the operating implement being present within one or more of the plurality of images, and generating the second signal in response to detecting the image features corresponding to the wearable portion of the operating implement.

Processing the at least one image to determine the condition of the operating implement may involve processing the at least one image to identify image features corresponding to a wearable portion of the operating implement.

The method may involve determining that the wearable portion of the operating implement has become detached or broken in response to the processing of the image failing to identify image features that correspond to the wearable portion of the operating implement.

The method may involve comparing the identified image features to a reference template associated with the wearable portion and determining the condition of the operating implement may involve determining a difference between the reference template and the identified image feature.

Causing the image sensor to capture at least one image may involve causing the image sensor to capture at least one thermal image of the operating implement.

Processing the at least one image to determine the condition of the operating implement may involve processing only portions of the image corresponding to a temperature above a threshold temperature.

The heavy operating equipment may be a backhoe and the image sensor may be disposed under a boom of the backhoe.

The heavy operating equipment may be a loader and the image sensor may be disposed under a boom of the loader.

The operating implement may include at least one tooth and determining the condition of the operating implement may involve processing the at least one image to determine the condition of the at least one tooth.

Processing the at least one image to determine the condition of the at least one tooth may involve processing the at least one image to determine whether the at least one tooth has become detached or broken.

The image sensor may include one of an analog video camera, a digital video camera, a time of flight camera, an image sensor responsive to infrared radiation wavelengths, and first and second spaced apart image sensors operable to generate a stereo image pairs for determining 3D image coordinates of the operating implement.

In accordance with another disclosed aspect there is provided an apparatus for monitoring a condition of an operating implement in heavy equipment. The apparatus includes an image sensor operable to capture at least one image of the operating implement in response to receiving a trigger signal indicating that the operating implement is within a field of view of an image sensor. The apparatus also includes a processor circuit operable to process the at least one image to determine the condition of the operating implement.

The image sensor may be operable to generate a plurality of images and the processor circuit may be operable to process the plurality of images to detect image features corresponding to the operating implement being present within one or more of the plurality of images, and generate the trigger signal in response to detecting the image features.

The apparatus may include a motion sensor disposed to provide a signal responsive to movement of the operating implement and to generate the trigger signal in response to the signal indicating that the operating implement is disposed within the field of view of the image sensor.

The motion sensor may be operable to generate a spatial positioning signal representing an orientation of a moveable support carrying the operating implement, and to generate the trigger signal in response to the spatial positioning signal indicating that the support is disposed in a spatial position that would place the operating implement within the field of view of the image sensor.

The motion sensor may include a plurality of motion sensors disposed to provide signals responsive to movement of the operating implement.

The processor circuit may be operably configured to process the motion sensor signal using a system model, the system model being operable to provide a position and orientation of the operating implement based on the motion sensor signal.

The moveable support may include a plurality of articulated linkages and the motion sensor may include a plurality of sensors disposed on one or more of the linkages and operable to generate spatial positioning signals for each respective linkage, the motion sensor being further operable to generate the trigger signal in response to each of the spatial positioning signals indicating that the support is disposed in a spatial position that would place the operating implement within the field of view of the image sensor.

The motion sensor may include one of an inertial sensor disposed on a portion of the heavy equipment involved in movement of the operating implement, a plurality of orientation and positioning sensors disposed on a portion of the heavy loading equipment involved in movement of the operating implement, a range finder disposed to detect a position of the operating implement, a laser sensor disposed to detect a position of the operating implement, and a radar sensor disposed to detect a position of the operating implement.

The motion sensor may include a sensor disposed to provide a signal responsive to a closest obstacle to the heavy equipment, and the motion sensor may be operable to generate the trigger signal in response to the signal responsive to the closest obstacle indicating that the closest obstacle is within an operating range associated with the operating implement.

The motion sensor may include one of a laser scanner operable to scan an environment surrounding the heavy equipment, a range finder operable to provide a distance to obstacles within the environment, a range finder sensor operable to detect objects within the environment, and a radar sensor operable to detect objects within the environment.

The trigger signal may include a first signal indicating that the operating implement may be within a field of view of an image sensor, a second signal indicating that a wearable portion of the operating implement is within the field of view of an image sensor, and the trigger signal may be generated in response to receiving the second signal after receiving the first signal.

The image sensor may be operable to capture a plurality of images and the processor circuit may be operable to generate the second signal by processing the plurality of images to detect image features corresponding to the wearable portion of the operating implement being present within one or more of the plurality of images, and generate the second signal in response to detecting the image features corresponding to the wearable portion of the operating implement.

The processor circuit may be operable to process the at least one image to determine the condition of the operating implement by processing the at least one image to identify image features corresponding to a wearable portion of the operating implement.

The processor circuit may be operable to determine that the wearable portion of the operating implement has become detached or broken following the processor circuit failing to identify image features that correspond to the wearable portion of the operating implement.

The processor circuit may be operable to compare the identified image features to a reference template associated with the wearable portion and to determine the condition of the operating implement by determining a difference between the reference template and the identified image feature.

The image sensor may be operable to capture at least one thermal image of the operating implement.

The processor circuit may be operable to process only portions of the image corresponding to a temperature above a threshold temperature.

The heavy operating equipment may be a backhoe and the image sensor may be disposed under a boom of the backhoe.

The heavy operating equipment may be a loader and the image sensor may be disposed under a boom of the loader.

The operating implement may include at least one tooth and the processor circuit may be operable to determine the condition of the operating implement by processing the at least one image to determine the condition of the at least one tooth.

The processor circuit may be operable to process the at least one image to determine whether the at least one tooth has become detached or broken.

The image sensor may include one of an analogue video camera, a digital video camera, a time of flight camera, an image sensor responsive to infrared radiation wavelengths, and first and second spaced apart image sensors operable to generate a stereo image pairs for determining 3D image coordinates of the operating implement.

The image sensor may be disposed on the heavy equipment below the operating implement and may further include a shield disposed above the image sensor to prevent damage to the image sensor by falling debris from a material being operated on by the operating implement.

The shield may include a plurality of spaced apart bars.

The apparatus may include an illumination source disposed to illuminate the field of view of the image sensor.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of an apparatus for monitoring a condition of an operating implement according to a first embodiment of the invention;

FIG. 2 is a view of the apparatus of FIG. 1 mounted on a wheel loader;

FIG. 3 is a view of a wheel loader in operation;

FIG. 4 is a view of a backhoe excavator in operation;

FIG. 5 is a block diagram of a processor circuit of the apparatus is shown in FIG. 1;

FIG. 6 is a process flowchart depicting blocks of code for directing the processor circuit of FIG. 5 to monitor the condition of an operating implement;

FIG. 7 is a process flowchart depicting blocks of code for directing the processor circuit of FIG. 5 to implement a portion of the process shown in FIG. 6;

FIG. 8 is a process flowchart depicting blocks of code for directing the processor circuit of FIG. 5 to implement a portion of the process shown in FIG. 7;

FIG. 9 is an example of an image captured by an image sensor 102 of the apparatus shown in FIG. 1;

FIG. 10 is a process flowchart depicting blocks of code for directing the processor circuit of FIG. 5 to implementing a portion of the process in FIG. 6;

FIG. 11 is a process flowchart depicting blocks of code for directing the processor circuit of FIG. 5 to determine the condition of a toothline of the operating implement;

FIG. 12 is a screenshot displayed on a display of the apparatus shown in FIG. 1;

FIG. 13 is a process flowchart depicting blocks of code for directing the processor circuit of FIG. 5 to implement an alternative process for implementing a portion of the process shown in FIG. 6;

FIG. 14 is an example of a stereoscopic image sensor for use in the apparatus shown in FIG. 1;

FIG. 15 is an example of a pair of stereo images provided by an alternative stereoscopic image sensor implemented in the apparatus shown in FIG. 1;

FIG. 16 is an example of a map of disparities between stereo images generated by the stereoscopic image sensor shown in FIG. 15;

FIG. 17 is an example of a thermal image sensor for use in the apparatus shown in FIG. 1;

FIG. 18 is an example of a thermal image provided by an alternative thermal image sensor implemented in the apparatus shown in FIG. 1;

FIG. 19 is block diagram of a system model for processing motion sensor signals; and

FIG. 20 is a process flowchart depicting blocks of code for directing the processor circuit of FIG. 5 to implement an alternative process for implementing a portion of the process shown in FIG. 7.

### DETAILED DESCRIPTION

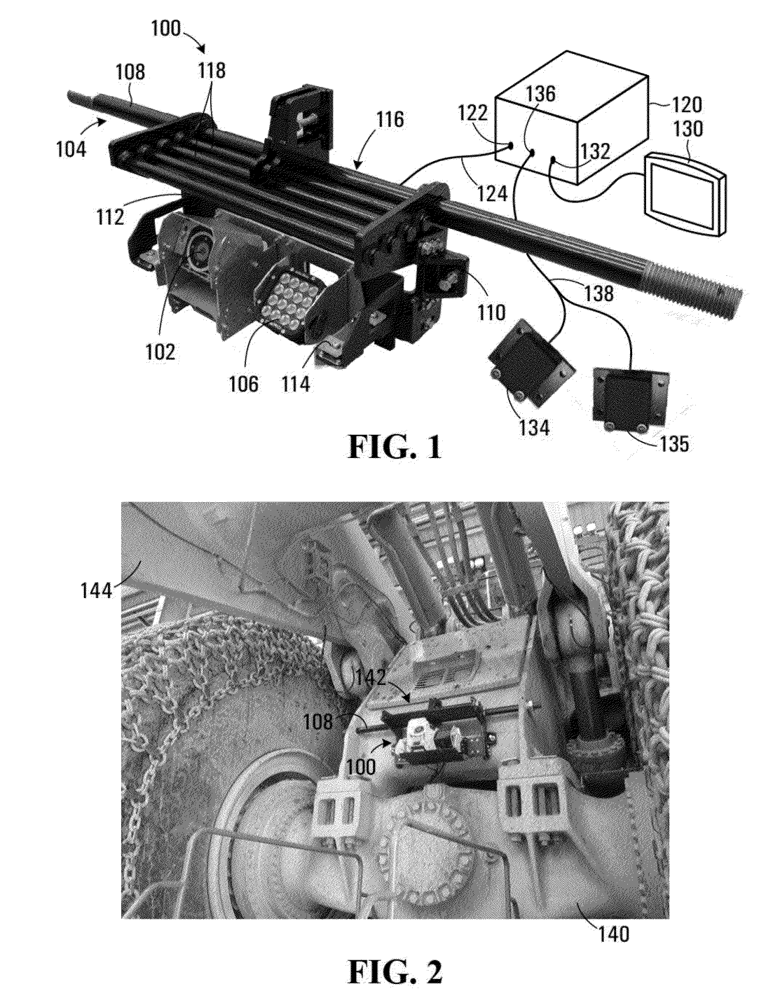

Referring to FIG. 1, an apparatus for monitoring a condition of an operating implement in heavy equipment according to a first embodiment of the invention is shown generally at 100. The apparatus 100 includes an image sensor 102 mounted on a bracket 104. In the embodiment shown the apparatus 100 also includes an illumination source 106 mounted on the bracket 104 for illuminating a field of view of the image sensor 102. The apparatus 100 may also include one or more motion sensors 134 and 135. In this embodiment the motion sensors 134 and 135 are inertial sensors, which may include accelerometers, gyroscopes, and magnetometers for generating orientation signals.

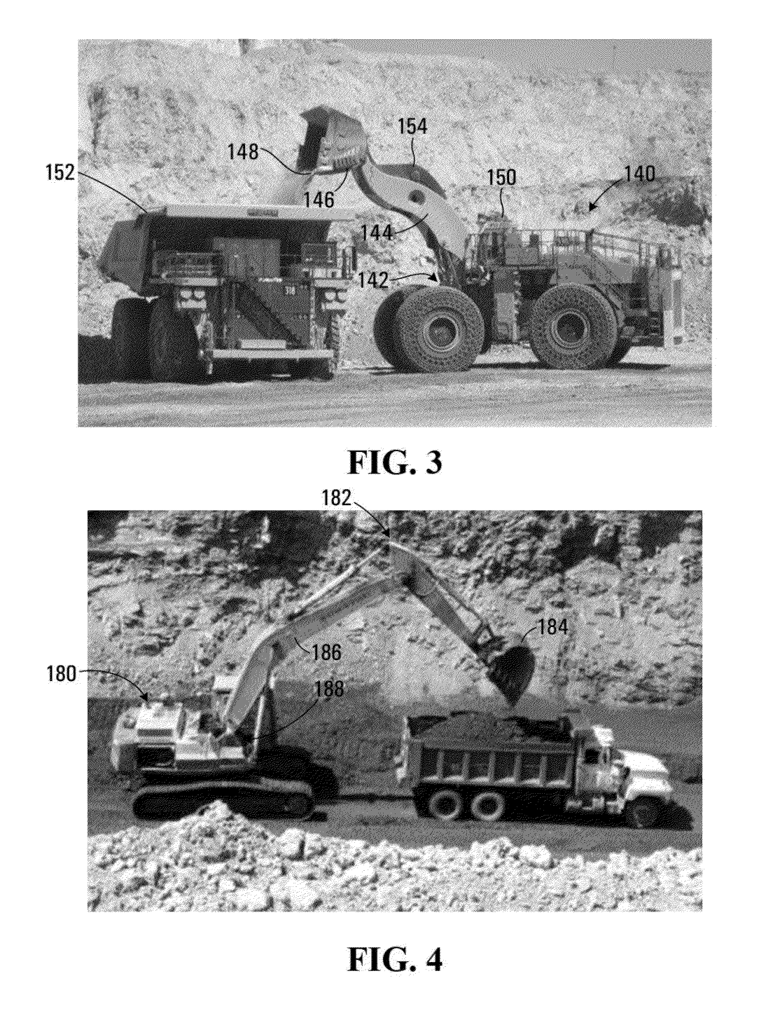

Referring to FIG. 2, in one embodiment the apparatus 100 is mounted on a wheel loader 140 at a mounting location 142 under a boom 144 of the loader. Referring to FIG. 3, the wheel loader 140 includes an operating implement 146, which for a loader is commonly referred to as a bucket. The operating implement 146 is carried on a boom 144, which includes an arm 154. The operating implement 146 has a plurality of wearable teeth 148, which are subject to wear or damage during operation of the wheel loader 140 to load material such as rock or mined ore for transport by, for example, a truck such as the truck 152 in FIG. 3.

Referring back to FIG. 1, the bracket 104 includes a bar 108 for mounting to the mounting location 142 of the wheel loader 140 and a pair of side-arms 110 and 112. The image sensor 102 and illumination source 106 are mounted between the side-arms 110 and 112 on a vibration isolating and shock absorbing platform 114. The bracket 104 also includes a shield 116 disposed above the image sensor 102 to prevent damage to the image sensor and illumination source 106 by falling debris such as rocks. In this embodiment the shield 116 includes a plurality of bars 118.

The apparatus 100 further includes a processor circuit 120, which has an input port 122 for receiving signals from the image sensor 102. In the embodiment shown the input 122 is coupled to a signal line 124, but in other embodiments the image sensor 102 and processor circuit 120 may be in wireless communication. The processor circuit 120 may be located remotely from the mounting location 142 of the bracket 104, such as in a cabin 150 of the wheel loader 140.

In the embodiment shown, the apparatus 100 further includes a display 130 coupled to a display output 132 of the processor circuit 120 for displaying results of the monitoring of the condition of the operating implement 146. The display 130 would generally be located in the cabin 150 for viewing by an operator of the wheel loader 140.

The processor circuit 120 has an input port 136 for receiving signals from the inertial sensors 134 and 135. In the embodiment shown the input 136 is coupled to a signal line 138, but in other embodiments the motion sensors 134, 135 and the processor circuit 120 may be in wireless communication.

In other embodiments, the apparatus 100 may be mounted on other types of heavy equipment, such as the backhoe excavator shown in FIG. 4 at 180. Referring to FIG. 4, the backhoe 180 includes an articulated arm 182 that carries a bucket operating implement 184. The articulated arm 182 has a boom 186 and in thus embodiment the apparatus 100 (not shown in FIG. 4) would be mounted at a location 188 under the boom 186, on the boom 186, or on the articulated arm 182.

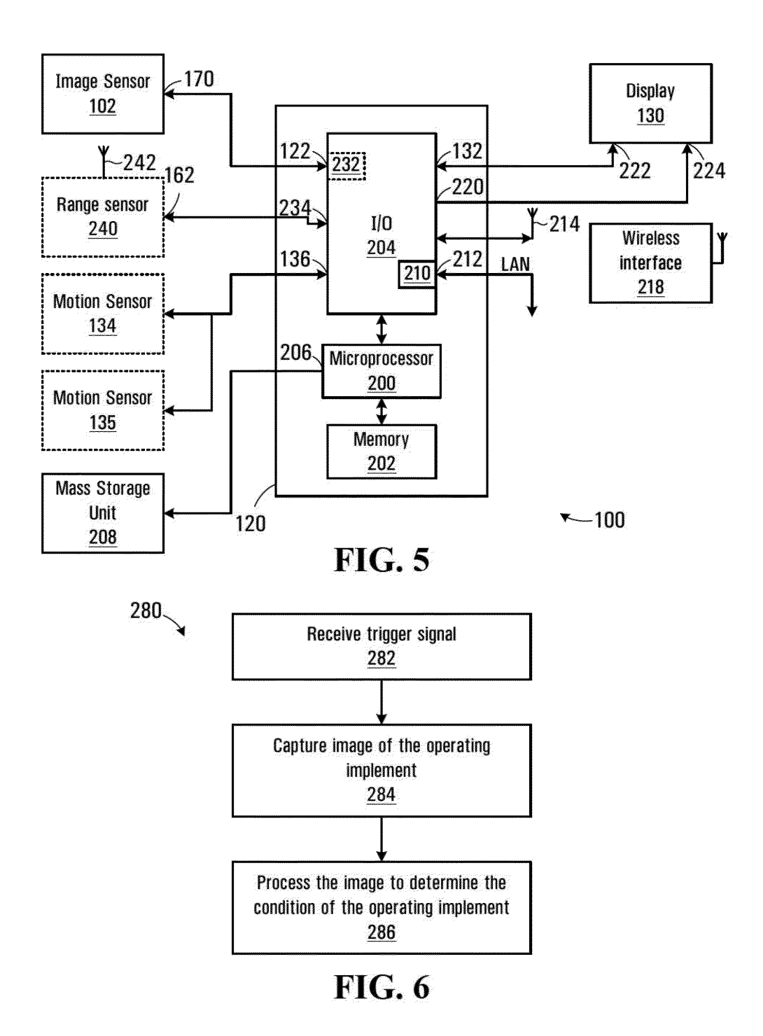

A block diagram of the apparatus 100 is shown in FIG. 5. Referring to FIG. 5, the processor circuit 120 includes a microprocessor 200, a memory 202, and an input output port (I/O) 204, all of which are in communication with the microprocessor 200. In one embodiment the processor circuit 120 may be optimized to perform image processing functions. The microprocessor 200 also includes an interface port (such as a SATA interface port) for connecting a mass storage unit such as a hard drive (HDU) 208. Program codes for directing the microprocessor 200 to carry out functions related to monitoring the condition of the operating implement 146 may be stored in the memory 202 or the mass storage unit 208. Measurements of the operating implement 146 and plurality of teeth 148 such as the bucket width, tooth height, size and spacing, number of teeth, and a reference binary template for each tooth may be pre-loaded into the memory 202 for use implementing the various processes as described in detail below. For some embodiments, pre-loaded values related to orientations of the boom 144 of the wheel loader 140 shown in FIG. 3 or articulated arm 182 of the backhoe excavator shown in FIG. 4 may also be pre-loaded in the memory 202.

The I/O 204 includes a network interface 210 having a port for connecting to a network such as the internet or other local network. The I/O 204 also includes a wireless interface 214 for connecting wirelessly to a wireless access point 218 for accessing a network. Program codes may be loaded into the memory 202 or mass storage unit 208 over the network using either the network interface 210 or wireless interface 214, for example.

The I/O 204 includes the display output 132 for producing display signals for driving the display 130 and a USB port 220. In this embodiment the display 130 is a touchscreen display and includes both a display signal input 222 in communication with the display output 132 and a touchscreen interface input/output 224 in communication with the USB port 220 for receiving touchscreen input from an operator. The I/O 204 may have additional USB ports (not shown) for connecting a keyboard or other peripheral interface devices.

The I/O 204 further includes the input port 122 (shown in FIG. 1) for receiving image signals from the image sensor 102. In one embodiment the image sensor 102 may be a digital camera and the image signal port 122 may be an IEEE 1394 (firewire) port, USB port, or other suitable port for receiving image signals. In other embodiments, the image sensor 102 may be an analog camera that produces NTSC or PAL video signals, for example, and the image signal port 122 may be an analog input of a framegrabber 232.

In some embodiments, the apparatus 100 may also include a range sensor 240 in addition to the motion sensors 134 and 135 (shown in FIG. 1) and the I/O 204 may include a port 234, such as a USB port, for interfacing to this sensor.

In other embodiments (not shown), the processor circuit 120 may be partly or fully implemented using a hardware logic circuit including discrete logic circuits and/or an application specific integrated circuit (ASIC), for example.

Referring to FIG. 6, a flowchart depicting blocks of code for directing the processor circuit 120 to monitor the condition of the operating implement 146 is shown generally at 280. The blocks generally represent codes that may be read from the memory 202 or mass storage unit 208 for directing the microprocessor 200 to perform various functions. The actual code to implement each block may be written in any suitable programming language, such as C, C++, C#, and/or assembly code, for example.

The process 280 begins at block 282, which directs the microprocessor 200 to receive a trigger signal indicating that the operating implement 146 is within a field of view of the image sensor 102. Referring back to FIG. 3, for the operating conditions shown an image sensor 102 located at the mounting location 142 under the boom 144, will have a view of the operating implement 146 and the plurality of teeth 148. However, under other operating conditions, the boom 144 and/or arm 154 may be lowered thus obscuring the view of the operating implement 146 and the plurality of teeth 148.

When the trigger signal is received, block 284 directs the microprocessor 200 to cause the image sensor 102 to capture at least one image of the operating implement 146. For a digital image sensor 102 having a plurality of pixels in rows and columns, the captured image will be represented by a data file including an intensity value for each of the plurality pixels. If the image sensor 102 is an analog image sensor, the framegrabber 232 shown in FIG. 5 receives the analog signal and converts the image on a frame-by-frame basis into pixel image data.

The process then continues at block 286, which directs the microprocessor 200 to process the at least one image to determine the condition of the operating implement 146. The processing may involve determining whether one of the pluralities of teeth 148 has become either completely or partially detached, in which case the detached portion may have ended up in the ore on the truck 152. In other embodiments the processing may also involve monitoring and determining a wear rate and condition associated with the teeth 148.

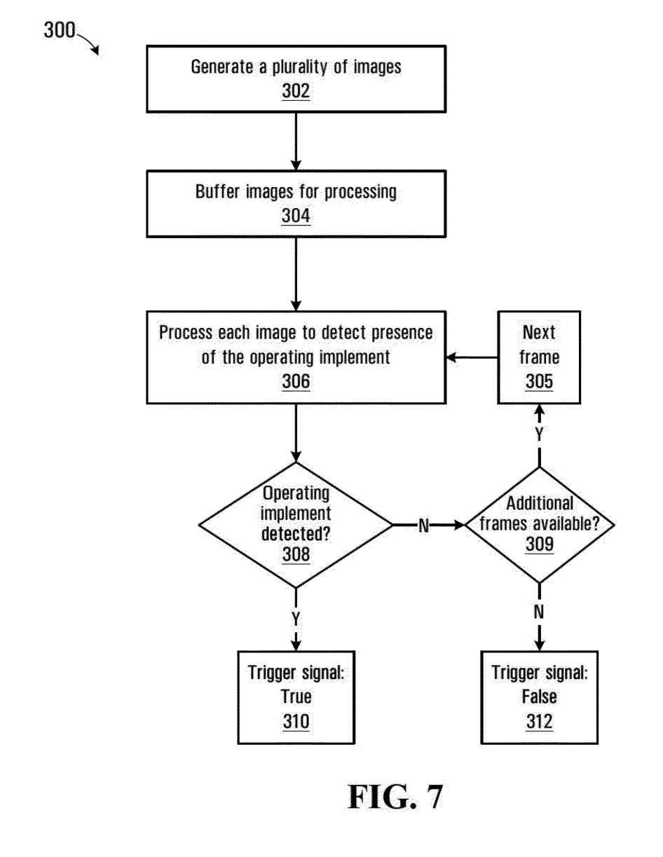

Referring to FIG. 7, one embodiment of a process for implementing block 282 of the process 280 is shown generally at 300. The process 300 begins at block 302, which directs the microprocessor 200 to cause the image sensor 102 to generate a plurality of images. In one embodiment block 302 directs the microprocessor 200 to cause the image sensor 102 to stream images at a suitable frame rate. The frame rate may be selected in accordance with the capability of the processor circuit 120 to process the images. Block 304 then directs the microprocessor 200 to buffer the images by saving the image data to the memory 202 shown in FIG. 5.

As disclosed above, the field of view of the image sensor 102 will generally be oriented such that under some operating conditions the operating implement 146 is within the field of view and under other operating conditions the operating implement is outside of the field of view. Block 306 then directs the microprocessor 200 to read the next image from the buffer in the memory 202 and to process the image to detect image features corresponding to the operating implement being present within the image being processed.

If at block 308 the operating implement 146 is not detected, block 308 directs the microprocessor 200 to block 309 where the microprocessor is directed to determine whether additional frames are available. If at block 309, additional frames are available, the process then continues at block 305, which directs the microprocessor 200 to select the next frame for processing. Block 305 then directs the microprocessor 200 back to block 308, and block 308 is repeated.

If at block 308 the operating implement 146 is detected, the process continues at block 310, which directs the microprocessor 200 to generate the trigger signal. In this embodiment the trigger signal may be implemented as a data flag stored in a location of the memory 202 that has a state indicating that the operating implement 146 is within the field of view of the image sensor 102. For example, the data flag may initially be set to data “0” indicating that the operating implement 146 has not yet been detected, and in response to detecting the image features of the operating implement, block 310 would direct the microprocessor 200 to set the flag to data “1”.

If at block 309, there are no additional frames available, the microprocessor 200 is directed to block 312, and the trigger signal is set to false i.e. data “0”.

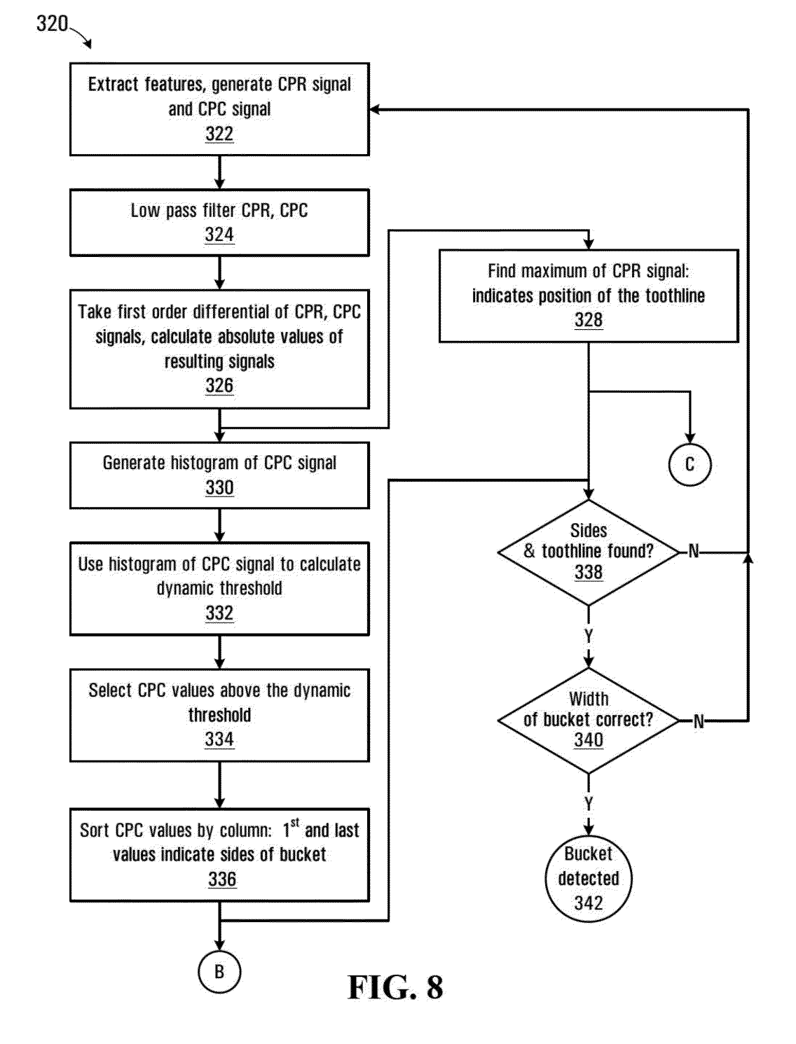

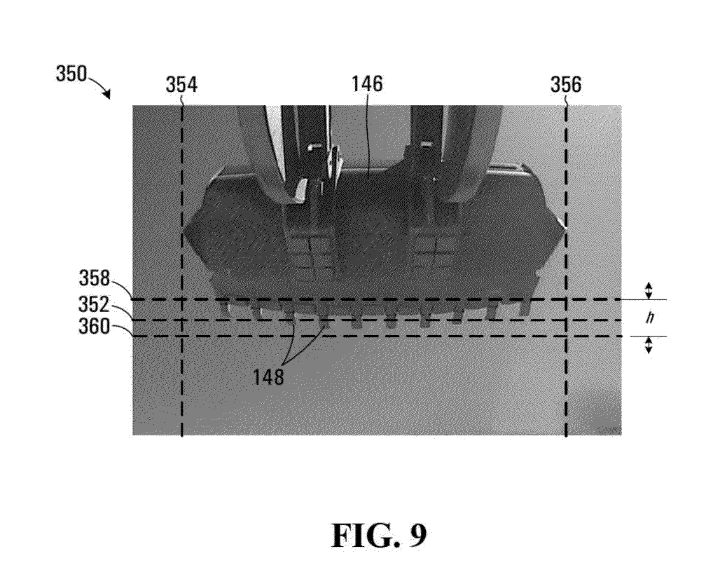

Referring to FIG. 8, one embodiment of a process for implementing blocks 306 and 308 of the process 300 is shown generally at 320. The process is described with reference to a bucket operating implement 146 having a plurality of teeth 148, such as shown in FIG. 3 for the wheel loader 140. The process 320 begins at block 322, which directs the microprocessor 200 to read the image from the buffer in the memory 202 (i.e. the buffer set up by block 304 of the process 300). An example of an image captured by the image sensor 102 is shown at 350 in FIG. 9.

Block 322 also directs the microprocessor 200 to process the image to extract features from the image. In this embodiment the feature extraction involves calculating cumulative pixel intensities for pixels in each row across the image (CPR data signal) and calculating cumulative pixel intensities for pixels in each column across the image (CPC data signal). Referring to FIG. 9, a line 352 is shown that corresponds to a row of pixels through a toothline of the plurality of teeth 148 in the image and lines 354 and 356 correspond to respective columns on either side of the bucket operating implement 146. The CPR and CPC signals will thus take the form of a series of values corresponding to the number of pixels in the respective rows and columns.

Block 324 then directs the microprocessor 200 to filter each of the CPR and CPC data signals using a low pass digital filter, such as a Butterworth low pass filter. The low pass filtering removes noise from the data signals resulting in filtered CPR and CPC data signals. The process 320 then continues at block 326, which directs the microprocessor 200 to take a first order differential of each filtered CPR and CPC data signal and to take the absolute value of the differentiated CPR and CPC data signals, which provides data signals that are proportional to the rate of change of the respective filtered CPR and CPC data signals.

For the differentiated CPR data signals, the process 320 continues at block 328, which directs the microprocessor 200 to find a global maximum of the differentiated filtered CPR data signals, which results in selection of a row having the greatest changes in pixel intensity across the row. Referring again to FIG. 9, the row 352 through the toothline of the plurality of teeth 148 exhibits the greatest changes in intensity due to the variations caused by the background areas and the spaced apart teeth.

For the differentiated CPC data signals, the process 320 continues at block 330, which directs the microprocessor 200 to generate a histogram of the differentiated CPC signal. Block 332 then directs the microprocessor 200 to use the histogram to select a dynamic threshold. Block 334 then thresholds the differentiated CPC data signal by selecting values that are above the dynamic threshold selected at block 332 resulting in the background areas of the image being set to zero intensity.

The process 320 then continues at block 336 which directs the microprocessor 200 to sort the thresholded CPC data signal based on column positions within the image and to select the first and last indices of the thresholded CPC data signals for each of the columns. Referring to FIG. 9, the resultant differentiated and thresholded CPC signals for columns to the left of the bucket operating implement 146 would thus have low values where the background is at low or zero intensity value. Columns that extend through the bucket operating implement 146 would have significantly greater signal values and the left hand side of the bucket can thus be picked out in the image as corresponding to a first column that has increased differentiated CPC signal values (i.e. the column 354). Similarly, the right hand side of the bucket can be picked out in the image as corresponding to a last column that has increased differentiated CPC signal values (i.e. the column 356).

The process 320 then continues at block 338, which directs the microprocessor 200 to determine whether the both the sides and toothline have been detected at the respective blocks 328 and 336, in which case the process continues at block 340. Block 340 directs the microprocessor 200 to calculate width between the lines 354 and 356 in pixels, which corresponds to the width of the bucket operating implement 146. Block 340 then directs the microprocessor 200 to verify that the width of the bucket operating implement 146 falls within a predetermined range of values, which acts as verification that the bucket has been correctly identified in the image. If at block 340 the width of the bucket operating implement 146 falls within the predetermined range of values, then the process 324 is completed at 342.

If at block 338 either the sides or the toothline have not been found, or at block 340 the width of the bucket operating implement 146 falls outside the predetermined range of values, blocks 338 and 340 direct the microprocessor 200 back to block 322 and the process 320 is repeated for the next image. The process 320 thus involves receiving a first trigger signal indicating that the operating implement 146 may be within a field of view of an image sensor 102 and a second signal indicating that the plurality of teeth 148 of the operating implement are within the field of view of an image sensor. The trigger signal is thus generated in response to receiving the second signal after receiving the first signal providing verification that not only is the operating implement 146 within the field of view, but also verification that the toothline is within the field of view.

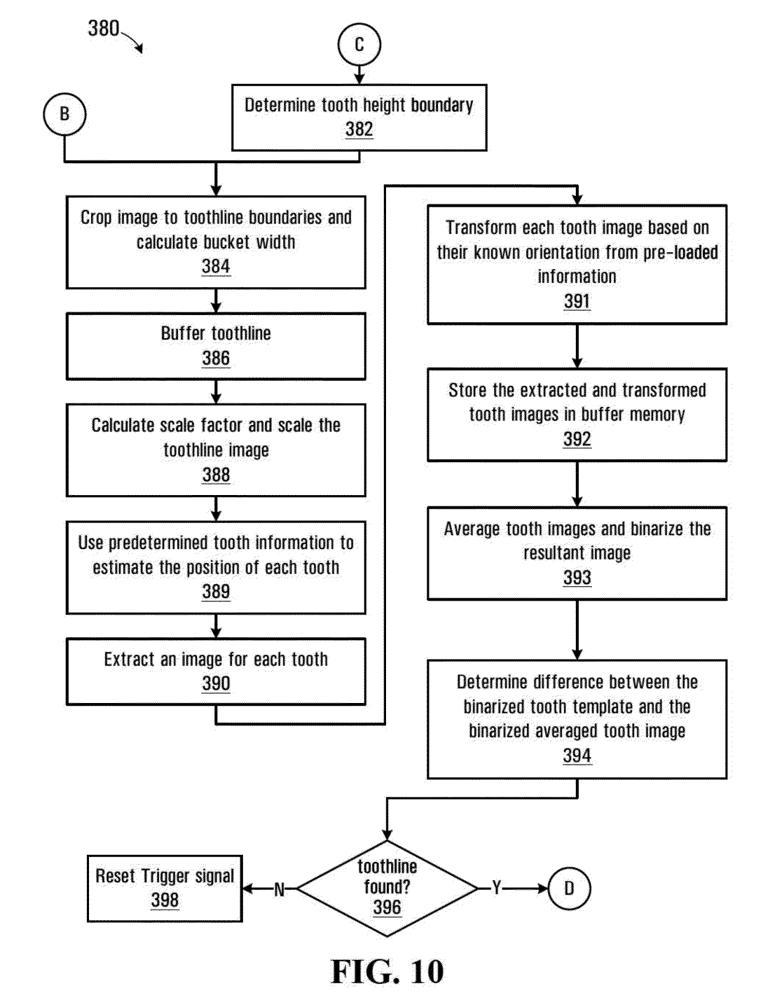

While the process 320 has been described in relation to a bucket operating implement 146 having a plurality of teeth 148, a similar process may be implemented for other types of operating implements. The process 320 acts as a coarse detection of the operating implement 146 being present within the field of view and in this embodiment precedes further processing of the image as described in connection with block 286 of the process 280. Referring to FIG. 10, one embodiment of a process for implementing block 286 of the process 280 is shown generally at 380. The process begins at block 382, which directs the microprocessor 200 to use the position of the toothline generated at block 328 (C) to calculate upper and lower boundaries of the toothline of the plurality of teeth 148. Referring to FIG. 9, the upper and lower boundaries are indicated by lines 358 and 360, which are located by spacing the lines on either side of the toothline position line 352 such that the distance between the lines 358 and 360 correspond to a maximum tooth height h that is pre-loaded in the memory 202.

The upper and lower boundaries 358 and 360 from block 382 together with the detected sides of the bucket operating implement 146 generated at block 336 (B) provide boundaries of the toothline of the plurality of teeth 148. Block 384 then directs the microprocessor 200 to crop the image 350 to the boundaries 354, 356, 358, and 360, and to store a copy to a toothline buffer in the memory 202. The buffered image thus includes only the toothline of the plurality of teeth 148. Block 384 also directs the microprocessor 200 to calculate the bucket width in pixels.

Block 388 then directs the microprocessor 200 to calculate a scaling factor. In this embodiment the scaling factor is taken as a ratio between a known bucket width pre-loaded in the memory 202 and the width of the bucket in pixels that was calculated at block 384 of the process 360. Block 388 also directs the microprocessor 200 to scale the toothline image in accordance with the scaling factor so that the image appears in the correct perspective.

Block 389 then directs the microprocessor 200 to estimate a position for each tooth in the toothline based on the number of teeth pre-loaded in the memory 202 and respective spacing between the teeth. The process then continues at block 390, which directs the microprocessor 200 to extract an image for each tooth based on a width and height of the tooth from pre-loaded information in the memory 202.

Block 391 then directs the microprocessor 200 to perform the 2D geometric image transformation for each tooth image based on their known orientation from pre-loaded information. Block 392 then directs the microprocessor 200 to store the extracted and transformed tooth images and the resulting tooth images are saved in a tooth image buffer in the memory 202.

Block 393 then directs the microprocessor 200 to average the extracted and transformed tooth images of current toothline and to binarize the resulted image such that each pixel is assigned a “0” or “1” intensity.

Block 394 then directs the microprocessor 200 to read the pre-loaded binarized tooth template from the memory 202 and determine a difference between the binarized tooth template and the binarized averaged tooth image for the current toothline.

Block 396 then directs the microprocessor 200 to compare a calculated difference in block 394 against a predetermined threshold and if the difference is less than the threshold it is determined that the toothline is not in the field of view of the image sensor 102. The process then continues at block 398 which directs the microprocessor 200 to reset the trigger signal to false. If at block 396, the toothline was found then the process continues with determination of the condition of the toothline of the operating implement 146.

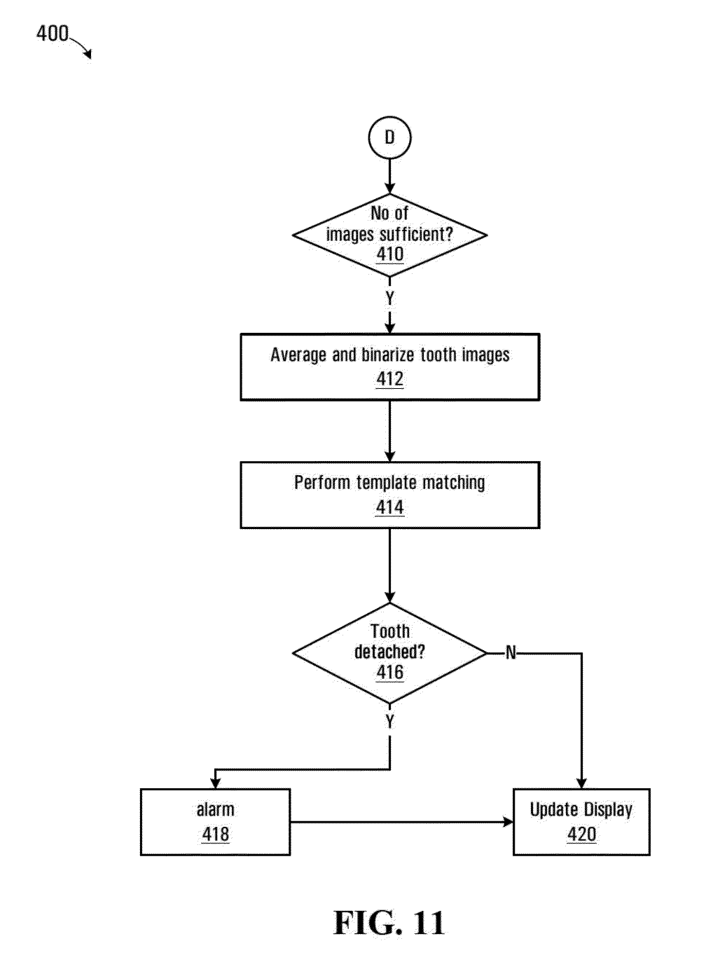

Referring to FIG. 11, an embodiment of a process for determining the condition of the toothline of the operating implement 146 is shown generally at 400. The process begins at block 410, which directs the microprocessor 200 to determine whether a sufficient number of images have been processed. In one embodiment as few images as a single image is processed but in other embodiments a greater number of images may be processed depending on the capabilities of the processor circuit 120. The image or images are processed and saved in the tooth image buffer in the memory 202, and at block 410 if further images are required, the microprocessor 200 is directed back to the process 380 and the next buffered toothline image in the memory 202 is processed. If at block 410 sufficient images have been processed the process continues at block 412, which directs the microprocessor 200 to retrieve the extracted and transformed tooth images from the memory 202 (i.e. the images that resulted from implementation of block 392 of the process 380) and to average the images and binarize the images such that each pixel is assigned a “0” or “1” intensity and each tooth is represented by a single averaged binary image. Block 412 then directs the microprocessor 200 to save the averaged binary tooth image for each tooth in the memory 202.

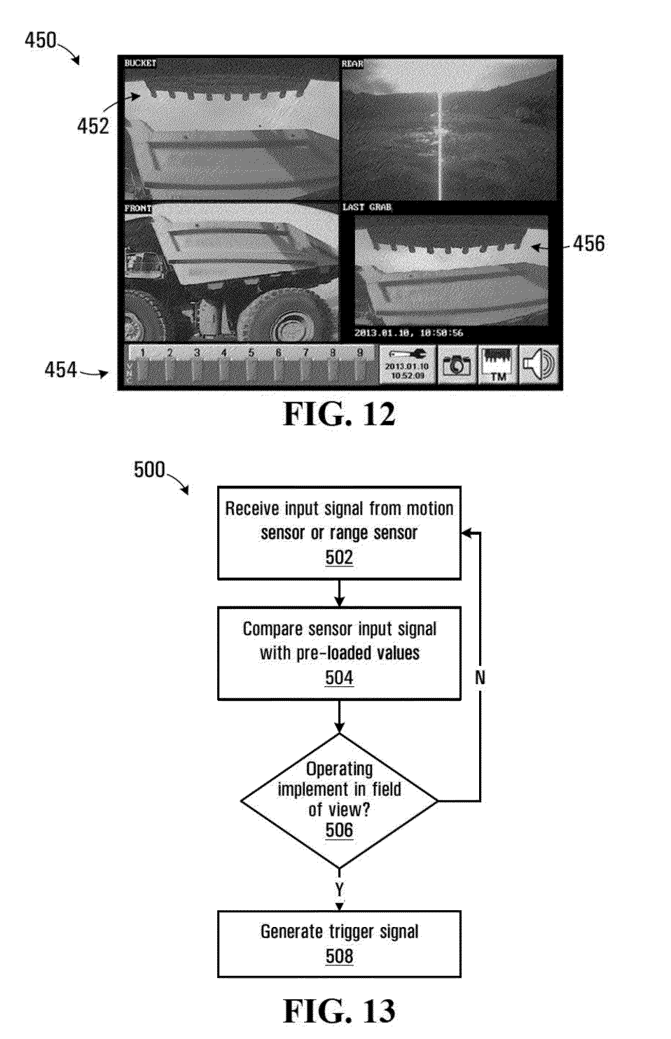

Block 414 then directs the microprocessor 200 to read the pre-loaded binary tooth template from the memory 202 and determine a difference between the tooth template and the binary tooth image for each tooth. Block 416 then directs the microprocessor 200 to compare the calculated difference for each tooth against a predetermined damage threshold and if the difference is less than the threshold the tooth is determined to be missing or damaged. Block 416 also directs the microprocessor 200 to calculate the wear rate of each tooth based on calculated difference. If a tooth is determined to be worn more than predetermined wear-threshold or the tooth is broken or missing block 416 directs the microprocessor 200 to block 418 and a warning is initiated. The warning may be displayed on the display 130 and may also be accompanied by an annunciation such as a warning tone being generated by the processor circuit 120. The process then continues at block 420, which directs the microprocessor 200 to update the display 130. Referring to FIG. 12, a screenshot is shown generally at 450 as an example of a displayed screen on the display 130 for viewing by an operator of the heavy equipment. The display includes a live view 452 of the bucket operating implement 146, a schematic representation 454 of the toothline, and the last image 456 of the plurality of teeth 148 which has been in the field of view of image sensor 102 and successfully analyzed by the disclosed process. In the case shown all teeth are present and undamaged.

If at block 416 the calculated difference is greater than the predetermined damage threshold the tooth is determined to present, in which case block 416 directs the microprocessor 200 to block 420 and the schematic representation 454 of the toothline will be updated by the new height of the teeth based on the calculated wearing rate at block 416.

### Alternative Process Embodiments

In other embodiments the apparatus may include the motion sensors 134 and 135 and the range sensor 240 shown in FIG. 1 and FIG. 5 for providing a signal responsive to movement of the operating implement 146. In embodiments where the apparatus 100 includes the motion or range sensors the trigger signal may be received from, or generated based on signals provided by the motion sensor.

In one embodiment the motion sensors 134 and 135 may be inertial sensors or other sensors positioned on a moveable support carrying the operating implement (for example the boom 144 and arm 154 of the wheel loader 140 shown in FIG. 3) and may be operable to generate a spatial positioning signal representing the orientation of the bucket. For the backhoe excavator shown in FIG. 4 the moveable support may be the boom 186 and/or other portion of the articulated arm 182 and a plurality of motion sensors may be disposed on linkages of the articulated arm for generating spatial positioning signals that can be used to generate the trigger signal.

Alternatively the range sensor 240 may be positioned to detect the operating implement 146 and/or surrounding environment. For example, the range sensor may be implemented using a laser scanner or radar system configured to generate a signal in response to a closest obstacle to the heavy equipment. When a distance to the closest obstacle as determined by the laser scanner or radar system is within a working range of the operating implement 146, the operating implement is likely to be within the field of view of the image sensor 102. In some embodiments the range sensor 240 may be carried on the platform 114 shown in FIG. 1.

Referring to FIG. 13, an alternative embodiment of a process for implementing block 282 of the process 280 is shown generally at 500. The process 500 begins at block 502, which directs the microprocessor 200 to receive input signals from the motion sensors 134 and 135 and/or the range sensor 240 (shown in FIG. 5). Block 504 then directs the microprocessor 200 to compare the motion and range sensor signal values with pre-loaded values in the memory 202. For example, the motion sensors 134 and 135 may be mounted on the boom 144 and the arm 154 of the wheel loader 140 shown in FIG. 3. The motion sensors 134 and 135 may be inertial sensors, each including accelerometers, gyroscopes, and magnetometers that provide an angular disposition of the boom 144 and arm 154. The pre-loaded values may provide a range of boom angles for which the operating implement 146 and/or the plurality of teeth 148 are likely to be in the field of view of the image sensor 102. For the backhoe excavator shown in FIG. 4, the more complex articulated arm 182 may require more than two inertial sensors to provide sufficient information to determine that the bucket operating implement 184 is likely to be in the field of view of the image sensor 102. Alternatively, the inertial sensors signal mounted on the boom linkages of the loader or backhoe provide the orientation of each linkage, and then Block 504 directs microprocessor 200 to calculate the position and orientation of the bucket and the toothline.

Block 506 then directs the microprocessor 200 to determine whether the operating implement 146 is within the field of view of the image sensor 102, in which case block 506 directs the microprocessor 200 to block 508. The process then continues at block 508, which directs the microprocessor 200 to generate the trigger signal. The capture and processing of images then continues as described above in connection with block 284 and 286 of the process 280. As disclosed above, generating the trigger signal may involve writing a value to a data flag indicating that the operating implement 146 is likely to be in the field of view.

If at block 506 the operating implement 146 is not within the field of view of the image sensor 102, block 506 directs the microprocessor 200 to back to block 502 and the process 500 is repeated.

Depending on the type of motion sensors 134 and 135 that are implemented, the process 500 may result in a determination that the operating implement 146 is only likely to be in the field of view of the image sensor 102, in which case the process 500 may be used as a precursor to other processes such as the process 300 shown in FIG. 7 and/or process 320 shown in FIG. 8. In this case, the use of the signal from the motion sensors 134 and 135 thus provides a trigger for initiating these processes, which then capture images to verify and detect the operating implement 146 and toothline of the plurality of teeth 148, for example.

In other embodiments, the motion sensors 134 and 135 may be implemented so as to provide a definitive location for the operating implement 146 and the processes 300 and 320 may be omitted. The process 500 would then act as a precursor for initiating the processes 380 shown in FIGS. 10 and 400 shown in FIG. 11 to process the image to determine the operating condition of the operating implement 146.

### Alternative Imaging Embodiments

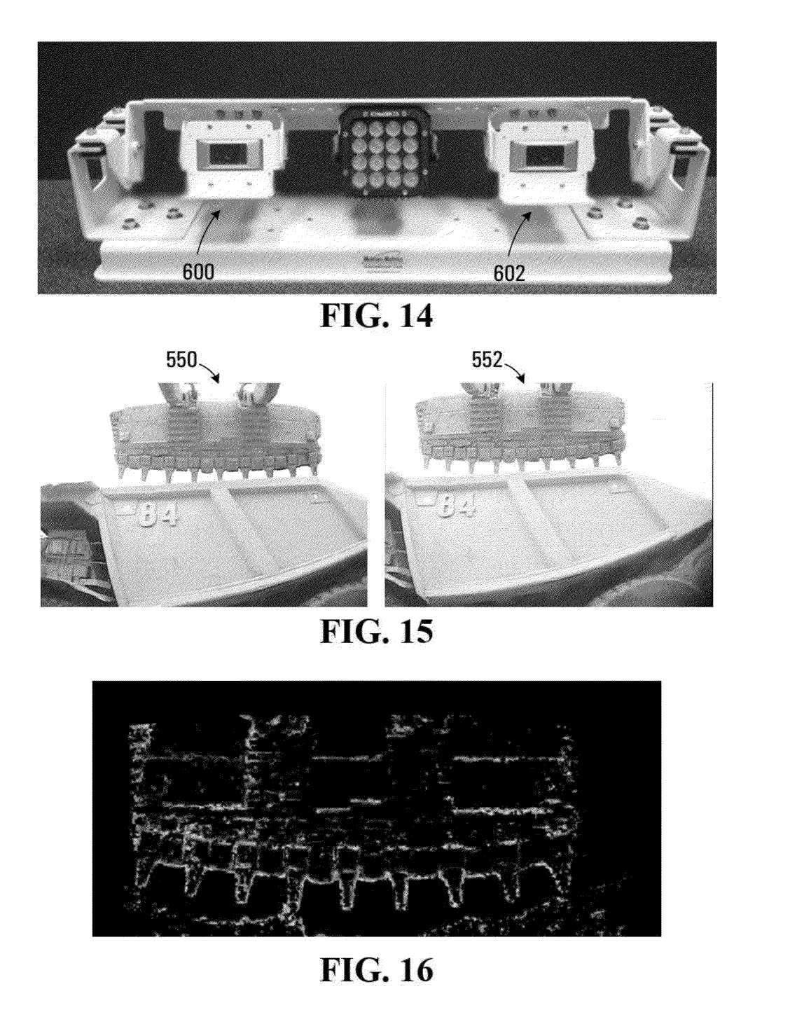

In an alternative embodiment the image sensor 102 may include first and second spaced apart image sensors as shown in FIG. 14 at 600 and 602, which are operable to generate a stereo image pairs for determining 3D image coordinates of the operating implement. Stereo image sensors are available and are commonly provided together with software drivers and libraries that can be loaded into the memory 202 of the processor circuit 120 to provide 3D image coordinates of objects with the field of view. An example of a pair of stereo images are shown in FIG. 15 and include a left image 550 provided by a left image sensor and a right image 552 provided by a right image sensor. The left and right images have a small disparity due to the spacing between the left and right image sensors which may be exploited to determine 3D coordinates or a 3D point cloud of point locations associated with objects, such as the teeth in the image shown in FIG. 15. An example of a map of disparities associated with the images 550 and 552 are shown in FIG. 16. The processes 300, 320, 380, 400, and 500 disclosed above may be adapted to work with 3D point locations, thus eliminating the need for pixel scaling. While incurring an additional processing overhead, the use of stereo images facilitates more precise dimensional comparisons for detecting the operating condition of the operating implement 146.

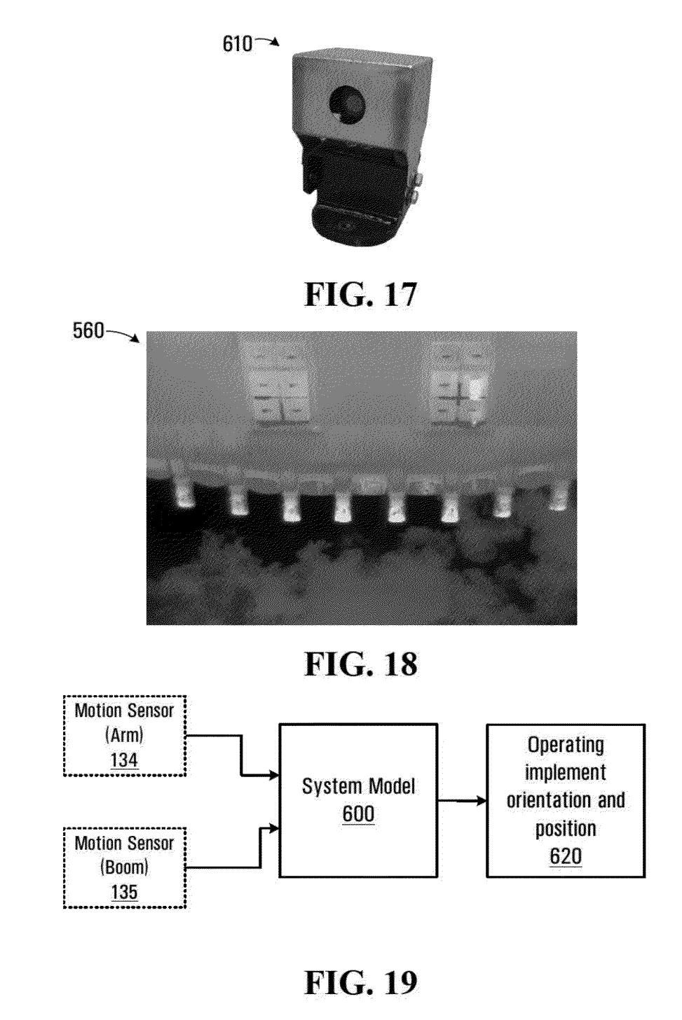

In another alternative embodiment, the image sensor 102 may be implemented using a thermal image sensor that has wavelength sensitivity in the infrared band of wavelengths. An example of a thermal image sensor is shown at 610 in FIG. 17 and an example of a thermal image acquired by the sensor is shown in FIG. 18 at 560. One advantage of a thermal image sensor is that the teeth of an operating implement 146 will usually be warmer than the remainder of the operating implement and the surrounding environment and would thus be enhanced in the images that are captured. Objects having less than certain temperature are thus generally not visible in captured images. The thermal image sensor also does not rely on illumination level to achieve a reasonable image contrast and therefore can be used in the daytime or nighttime without additional illumination such as would be provided by the illumination source 106 shown in FIG. 1. Advantageously, thermal images thus require less processing than visible spectrum images and several pre-processing steps may be eliminated, thus improving the responsiveness of the system. For example, steps such as low pass filtering (block 324 of the process 320), removing image background (blocks 330-334 of the process 320), and binarization (block 412 of the process 400) may be omitted when processing thermal images. This increases the processing speed and thus improves the responsiveness of the system to an operating implement 146 moving into the field of view of the image sensor 102.

### System Model

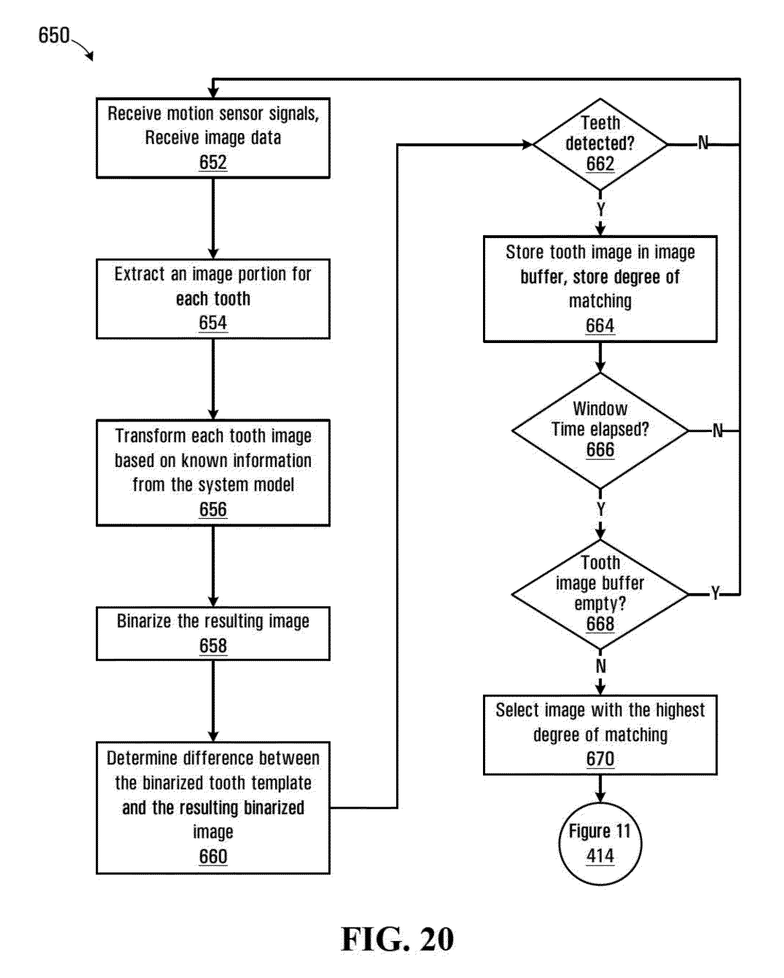

For some heavy equipment having complex mechanical linkages for moving the operating implement, a system model may be used to precisely determine the position and orientation of the operating implement. Referring to FIG. 19, a process implementing a system model process is shown at 600. The motion sensor 134 may be mounted on an arm of the heavy equipment (for example the arm 154 of the wheel loader 140 shown in FIG. 3 or the arm of the backhoe 180 shown in FIG. 4). The motion sensor 135 may be mounted on the boom (for example the boom 144 of the wheel loader 140 or the boom 186 of the backhoe 180). The motion sensor signals are received by the processor circuit 120 (shown in FIG. 5) and used as inputs for a system model that maps the arm and boom orientation derived from the motion sensor signals to an operating implement orientation and position. The model may be derived from the kinematics of the arm and boom of the wheel loader 140 or backhoe 180 and the location of the image sensor 102. Alternatively a probabilistic model such as a regression model may be generated based on a calibration of the system at different operating implement positions.

In one embodiment the system model uses the attitude of the arm and boom of the wheel loader 140 or backhoe 180 to determine the position of the each tooth of the operating implement with respect to the image sensor 102. The system model thus facilitates a determination of the scale factor for scaling each tooth in the toothline image. For example, if the operating implement is pivoted away from the image sensor 102, the teeth in the toothline image would appear to be shorter than if the implement were to be pivoted toward the image sensor.

Referring to FIG. 20, an alternative embodiment of a process for implementing blocks 306 and 308 of the process 300 is shown generally at 650. The process 650 begins at block 652, which directs the microprocessor 200 to receive the motion sensor signals from the motion sensor 134 and motion sensor 135 and to read the toothline image from the image buffer in the memory 202.

Block 654 then directs the microprocessor 200 to extract an image portion for each tooth from the image stored in the memory 202. A plurality of tooth images are thus generated from the toothline image, and block 654 also directs the microprocessor 200 to store each tooth image in the memory 202.

Block 656 then directs the microprocessor 200 to use the generated system model to transform each image based on the motion sensor inputs for the arm and boom attitude. The system model transformation scales and transforms the tooth image based on the determined position and orientation of the operating implement. Block 658 then directs the microprocessor 202 to convert the image into a binary image suitable for further image processing.

Block 660 then directs the microprocessor 200 to read the pre-loaded binary tooth template from the memory 202 and determine a difference between the tooth template and the transformed binary tooth image for each tooth. Block 662 then directs the microprocessor 200 to determine whether each tooth has been detected based on a degree of matching between the transformed binary image of each tooth and the tooth template. If at block 662, the teeth have not been detected then the microprocessor 200 is directed back to block 652 and the process steps 652 to 662 are repeated. If at block 662, the teeth have been detected the process then continues at block 664, which directs the microprocessor 200 to store the tooth image in the memory 202 along with the degree of matching and a timestamp recording a time associated with the image capture.

Block 666 then directs the microprocessor 200 to determine whether a window time has elapsed. In this process embodiment a plurality of tooth images are acquired and transformed during a pre-determined window time and if the window time has not yet elapsed, the microprocessor 202 is directed back to block 652 to receive and process further images of the toothline.

If at block 666, the window time has elapsed the process then continues at block 668, which directs the microprocessor 200 to determine whether there are any tooth images in the image buffer memory 202. In some cases the operating implement may be disposed such that the toothline is not visible, in which case toothline images would not be captured and the image buffer in the memory 202 would be empty. If at block 668 the tooth image buffer is empty, then the microprocessor 200 is directed back to block 652 and the process 650 is repeated. If at block 668 the tooth image buffer is not empty, then the process 650 continues at block 670, which directs the microprocessor 200 to select a tooth image with the highest degree of matching.

The process 650 then continues as described above at block 414 of the process 400 shown in FIG. 400. The image selected at block 670 is used in the template matching step (block 414) and blocks 416-420 are completed as described above.

While specific embodiments of the invention have been described and illustrated, such embodiments should be considered illustrative of the invention only and not as limiting the invention as construed in accordance with the accompanying claims.

What is claimed is:

1. A method for monitoring a condition of an operating implement in heavy equipment, the method comprising:
receiving a trigger signal indicating that the operating implement is within a field of view of an image sensor;
in response to receiving the trigger signal, causing the image sensor to capture at least one image of the operating implement; and
processing the at least one image to determine the condition of the operating implement.

2. The method of claim 1 wherein receiving the trigger signal comprises receiving a plurality of images from the image sensor and further comprising:
processing the plurality of images to detect image features corresponding to the operating implement being present within one or more of the plurality of images; and
generating the trigger signal in response to detecting the image features.

3. The method of claim 1 wherein receiving the trigger signal comprises:
receiving a signal from a motion sensor disposed to provide a signal responsive to movement of the operating implement; and
generating the trigger signal in response to the signal responsive to movement of the operating implement indicating that the operating implement is disposed within the field of view of the image sensor.

4. The method of claim 3 wherein receiving the signal from the motion sensor comprises receiving signals from a plurality of motion sensors disposed to provide signals responsive to movement of the operating implement.

5. The method of claim 4 further comprising generating a system model, the system model being operable to provide a position and orientation of the operating implement based on the motion sensor signals.

6. The method of claim 3 wherein receiving the signal responsive to movement of the operating implement comprises receiving a spatial positioning signal representing an orientation of a moveable support carrying the operating implement, and wherein generating the trigger signal comprise generating the trigger signal in response to the spatial positioning signal indicating that the support is disposed in a spatial position that would place the operating implement within the field of view of the image sensor.

7. The method of claim 6 wherein the moveable support comprises a plurality of articulated linkages and wherein receiving the spatial positioning signal comprises receiving spatial positioning signals associated with more than one of the linkages and wherein generating the trigger signal comprise generating the trigger signal in response to each of the spatial positioning signals indicating that the support is disposed in a spatial position that would place the operating implement within the field of view of the image sensor.

8. The method of claim 3 wherein receiving the signal from the motion sensor comprises receiving a signal from at least one of:
an inertial sensor disposed on a portion of the heavy equipment involved in movement of the operating implement;
a plurality of orientation and positioning sensors disposed on a portion of the heavy loading equipment involved in movement of the operating implement;
a range finder disposed to detect a position of the operating implement;
a laser sensor disposed to detect a position of the operating implement; and
a radar sensor disposed to detect a position of the operating implement.

9. The method of claim 1 wherein receiving the trigger signal comprises:
receiving a signal from a motion sensor disposed to provide a signal responsive to a closest obstacle to the heavy equipment; and
generating the trigger signal in response to the signal responsive to the closest obstacle indicating that the closest obstacle is within an operating range associated with the operating implement.

10. The method of claim 9 wherein receiving the signal from the motion sensor comprises receiving a signal from one of:
a laser scanner operable to scan an environment surrounding the heavy equipment;
a range finder operable to provide a distance to obstacles within the environment;
a range finder sensor operable to detect objects within the environment; and
a radar sensor operable to detect objects within the environment.

11. The method of claim 1 wherein receiving the trigger signal comprises:
receiving a first signal indicating that the operating implement is within an field of view of an image sensor;
receiving a second signal indicating that a wearable portion of the operating implement is within the field of view of an image sensor; and
generating the trigger signal in response to receiving the second signal after receiving the first signal.

12. The method of claim 11 wherein receiving the second signal comprises receiving a plurality of images from the image sensor and further comprising:
processing the plurality of images to detect image features corresponding to the wearable portion of the operating implement being present within one or more of the plurality of images; and
generating the second signal in response to detecting the image features corresponding to the wearable portion of the operating implement.

13. The method of claim 1 wherein processing the at least one image to determine the condition of the operating implement comprises processing the at least one image to identify image features corresponding to a wearable portion of the operating implement.

14. The method of claim 13 further comprising determining that the wearable portion of the operating implement has become detached or broken in response to the processing of the image failing to identify image features that correspond to the wearable portion of the operating implement.

15. The method of claim 13 further comprising comparing the identified image features to a reference template associated with the wearable portion and wherein determining the condition of the operating implement comprises determining a difference between the reference template and the identified image feature.

16. The method of claim 1 wherein causing the image sensor to capture at least one image comprises causing the image sensor to capture at least one thermal image of the operating implement.

17. The method of claim 16 wherein processing the at least one image to determine the condition of the operating implement comprises processing only portions of the image corresponding to a temperature above a threshold temperature.

18. The method of claim 1 wherein the heavy operating equipment comprises a backhoe and wherein the image sensor is disposed under a boom of the backhoe.

19. The method of claim 1 wherein the heavy operating equipment comprises a loader and wherein the image sensor is disposed under a boom of the loader.

20. The method of claim 1 wherein the operating implement comprises at least one tooth and wherein determining the condition of the operating implement comprises processing the at least one image to determine the condition of the at least one tooth.

21. The method of claim 20 wherein processing the at least one image to determine the condition of the at least one tooth comprises processing the at least one image to determine whether the at least one tooth has become detached or broken.

22. The method of claim 1 wherein the image sensor comprises one of:
an analog video camera;
a digital video camera;
a time of flight camera;
an image sensor responsive to infrared radiation wavelengths; and
first and second spaced apart image sensors operable to generate a stereo image pairs for determining 3D image coordinates of the operating implement.

23. An apparatus for monitoring a condition of an operating implement in heavy equipment, the apparatus comprising:
an image sensor operable to capture at least one image of the operating implement in response to receiving a trigger signal indicating that the operating implement is within a field of view of an image sensor; and
a processor circuit operable to process the at least one image to determine the condition of the operating implement.

24. The apparatus of claim 23 wherein the image sensor is operable to generate a plurality of images and wherein the processor circuit is operable to:
process the plurality of images to detect image features corresponding to the operating implement being present within one or more of the plurality of images; and
generate the trigger signal in response to detecting the image features.

25. The apparatus of claim 23 further comprising a motion sensor disposed to provide a signal responsive to movement of the operating implement and to generate the trigger signal in response to the signal indicating that the operating implement is disposed within the field of view of the image sensor.

26. The apparatus of claim 25 wherein the motion sensor comprises a plurality of motion sensors disposed to provide signals responsive to movement of the operating implement.

27. The apparatus of claim 25 wherein the motion sensor is operable to generate a spatial positioning signal representing an orientation of a moveable support carrying the operating implement, and to generate the trigger signal in response to the spatial positioning signal indicating that the support is disposed in a spatial position that would place the operating implement within the field of view of the image sensor.

28. The apparatus of claim 27 wherein the processor circuit is operably configured to process the motion sensor signal using a system model, the system model being operable to provide a position and orientation of the operating implement based on the motion sensor signal.

29. The apparatus of claim 27 wherein the moveable support comprises a plurality of articulated linkages and wherein the motion sensor comprises a plurality of sensors disposed on one or more of the linkages and operable to generate spatial positioning signals for each respective linkage, the motion sensor being further operable to generate the trigger signal in response to each of the spatial positioning signals indicating that the support is disposed in a spatial position that would place the operating implement within the field of view of the image sensor.

30. The apparatus of claim 25 wherein the motion sensor comprises one of:
an inertial sensor disposed on a portion of the heavy equipment involved in movement of the operating implement;
a plurality of orientation and positioning sensors disposed on a portion of the heavy loading equipment involved in movement of the operating implement;
a range finder disposed to detect a position of the operating implement;
a laser sensor disposed to detect a position of the operating implement; and
a radar sensor disposed to detect a position of the operating implement.

31. The apparatus of claim 25 wherein the motion sensor comprises a sensor disposed to provide a signal responsive to a closest obstacle to the heavy equipment, and wherein the motion sensor is operable to generate the trigger signal in response to the signal responsive to the closest obstacle indicating that the closest obstacle is within an operating range associated with the operating implement.

32. The apparatus of claim 31 wherein the motion sensor comprises one of:
a laser scanner operable to scan an environment surrounding the heavy equipment;
a range finder operable to provide a distance to obstacles within the environment;
a range finder sensor operable to detect objects within the environment; and
a radar sensor operable to detect objects within the environment.

33. The apparatus of claim 23 wherein the trigger signal comprises:
a first signal indicating that the operating implement is within an field of view of an image sensor;
a second signal indicating that a wearable portion of the operating implement is within the field of view of an image sensor; and
wherein the trigger signal is generated in response to receiving the second signal after receiving the first signal.

34. The apparatus of claim 33 wherein the image sensor is operable to capture a plurality of images and wherein the processor circuit is operable to generate the second signal by:
processing the plurality of images to detect image features corresponding to the wearable portion of the operating implement being present within one or more of the plurality of images; and
generate the second signal in response to detecting the image features corresponding to the wearable portion of the operating implement.

35. The apparatus of claim 23 wherein the processor circuit is operable to process the at least one image to determine the condition of the operating implement by processing the at least one image to identify image features corresponding to a wearable portion of the operating implement.

36. The apparatus of claim 35 wherein the processor circuit is operable to determine that the wearable portion of the operating implement has become detached or broken following the processor circuit failing to identify image features that correspond to the wearable portion of the operating implement.

37. The apparatus of claim 35 wherein the processor circuit is operable to compare the identified image features to a reference template associated with the wearable portion and to determine the condition of the operating implement by determining a difference between the reference template and the identified image feature.

38. The apparatus of claim 23 wherein the image sensor is operable to capture at least one thermal image of the operating implement.

39. The apparatus of claim 38 wherein the processor circuit is operable to process only portions of the image corresponding to a temperature above a threshold temperature.

40. The apparatus of claim 23 wherein the heavy operating equipment comprises a backhoe and wherein the image sensor is disposed under a boom of the backhoe.

41. The apparatus of claim 23 wherein the heavy operating equipment comprises a loader and wherein the image sensor is disposed under a boom of the loader.

42. The apparatus of claim 23 wherein the operating implement comprises at least one tooth and wherein the processor circuit is operable to determine the condition of the operating implement by processing the at least one image to determine the condition of the at least one tooth.

43. The apparatus of claim 42 the processor circuit is operable to process the at least one image to determine whether the at least one tooth has become detached or broken.

44. The apparatus of claim 23 wherein the image sensor comprises one of:
an analogue video camera;
a digital video camera;
a time of flight camera;
an image sensor responsive to infrared radiation wavelengths; and
first and second spaced apart image sensors operable to generate a stereo image pairs for determining 3D image coordinates of the operating implement.

45. The apparatus of claim 23 wherein the image sensor is disposed on the heavy equipment below the operating implement and further comprising a shield disposed above the image sensor to prevent damage to the image sensor by falling debris from a material being operated on by the operating implement.

46. The apparatus of claim 45 wherein the shield comprises a plurality of spaced apart bars.

47. The apparatus of claim 23 further comprising an illumination source disposed to illuminate the field of view of the image sensor.
